(19) United States
(12) Patent Application Publication
(10) Pub. No.: US 2017/0313873 A1
(43) Pub. Date: Nov. 2, 2017

(54) THERMOPLASTIC MOULDING MATERIALS

(71) Applicant: LANXESS DEUTSCHLAND GMBH, COLOGNE (DE)

(72) Inventors: ULRICH PLUTOWSKI, DORMAGEN (DE); BORIS NEUWALD, KOLN (DE); SARAH SANGERMANN, KOLN (DE); MATTHIAS BIENMULLER, KREFELD (DE); RALF ZIMNOL, OVERATH (DE)

(73) Assignee: LANXESS DEUTSCHLAND GMBH, COLOGNE (DE)

(21) Appl. No.: 15/498,570

(22) Filed: Apr. 27, 2017

(30) Foreign Application Priority Data
Apr. 28, 2016 (EP) 16167447.8
Nov. 11, 2016 (EP) 16198341.6

(51) Int. Cl. C08L 67/02; C08K 7/20; C08K 5/42; B05D 1/04; B29C 47/00; C08K 3/00; B29K 71/00

(52) U.S. Cl. CPC C08L 67/02; B29C 47/0004; C08K 7/20; C08K 5/42; C08K 3/0033; B05D 1/04; B29C 47/0038; B29C 47/0011; C08L 2205/06; B29K 2071/00

(57) ABSTRACT

The invention relates to compositions, molding materials producible from the compositions, and to articles of manufacture in turn based on the molding materials, wherein the compositions comprise polyalkylene terephthalate or polyalkylene furanoate, at least one filler or reinforcer, and at least one secondary alkanesulfonate having two alkyl radicals.

The invention relates to compositions, molding materials producible from the compositions, and to articles of manufacture in turn based on the molding materials, wherein the compositions comprise polyalkylene terephthalate or polyalkylene furanoate, at least one filler or reinforcer, and at least one secondary alkanesulfonate having two alkyl radicals.

### BACKGROUND INFORMATION

It is disclosed in Kunststoffe, Eigenschaften und Anwendungen, H. Domininghaus et. al. 2008, Chapter 2.2 Synthetische Kunststoffe, Polykondensate, page 874, 2008, Springer (ISBN 978-540-72400-1) that painting of polybutylene terephthalate (PBT) based articles of manufacture may be achieved with various paint systems, for example Hydro-Soft paints. The motor vehicle industry is also aware of primer and paint systems allowing online painting of PBT up to 160° C. According to Standothek, Kunstetoffe und ihre Lackierung, Product brochure from Standox, Wuppertal, D12185782 D1007 5500, numerous problems may occur during painting which in turn depend on a multiplicity of parameters. These include, merely by way of example, insufficient pretreatment, unsuitable solvent, premature painting after cleaning, adhesion problems due to unsuitable adhesion promoters, flow problems due to unsuitable solvents etc. PBT based articles of manufacture may be found predominantly in motor vehicle exterior body parts, in particular in wings and boot lids, as visible vehicle components where painting must be particularly good.

WO 2016/022243 A1 discloses compositions comprising a polyester having 1,4-cyclohexane dimethylene terephthalate units, a halogen-free polycarbonate, a brominated aromatic polycarbonate and an unsubstituted or substituted C₂-C₁₈-hydrocarbylsulfonic acid salt having improved flame retardancy and improved transparency. 3-(phenylsulfonyl)benzenesulfonate potassium salt [CAS Nr, 63316-43-8] is employed in particular.

EP0372799 A2 discloses thermoplastic polyester compositions comprising an anionic sulfonate-type antistatic agent and also an organophosphorus compound and an organic chelating agent. Sulfonate-type agents employed are linear metal alkyl sulfonates, such as sodium dodecylsulfonate or metal alkylaromatic sulfonates.

EP 0373465 A2 relates to thermoplastic molding materials based on polyalkylene terephthalate, aromatic polycarbonate and optionally elastomeric polymer which are provided with special stabilizers and to molded articles produced from the thermoplastic molding materials. Only by addition of a combination of special phosphorus compounds are molding materials obtained with which palatability and paint adhesion of articles of manufacture produced therefrom is markedly improved.

In contrast to polyalkylene terephthalates polycarbonate (PC) is an amorphous thermoplastic. Amorphous material is understood in physics and chemistry to mean a substance where the atoms do not form ordered structures but rather form an irregular pattern and exhibit only short-range order but not long-range order. The amorphicity of the PC invariably improves surface characteristics and impact resistance and thus generally simplifies paint adhesion.

However, the problem addressed by the present invention is that of providing, without using polycarbonate, polyalkylene terephthalate based compositions for molding materials which on account of theft chemical composition reduce the occurrence of the above-described painting defects on articles of manufacture producible by injection molding and thus afford a painter greater freedom in the choice of the paint system to be employed, in particular in the case of electrostatic spraying (ESTA). This is because polyalkylene terephthalates have the advantage that they are better suited for processing in injection molding on account of the more convenient cooling and process behavior compared to PC.

### SUMMARY OF THE INVENTION

The solution to the problem and the subject-matter of the invention is provided by compositions, molding materials produced from the compositions, and in turn articles of manufacture produced from the molding materials, wherein the compositions comprise

A) at least one of polyalkylene terephthalate and polyalkylene furanoate, preferably polyethylene terephthalate or polybutylene terephthalate,

B) at least one filler or reinforce, and

C) at least one secondary alkanesulfonate having two alkyl radicals.

Surprisingly, the articles of manufacture based on the compositions according to the invention show a markedly reduced specific surface resistance compared to the prior art and are thus exceptionally suitable for articles of manufacture, which, after their production, are subjected to painting, in particular for articles of manufacture which are subjected to painting by electrostatic spraying (ESTA). Articles of manufacture according to the invention additionally feature a combination of high heat resistance, improved paint adhesion, low surface resistance and increased surface tension which makes it possible to coat these articles of manufacture by ESTA methods in painting lines in a mass production process.

Articles of manufacture according to the invention additionally show sufficient heat resistance to pass through the complete online process of the Original Equipment Manufacturer (OEM). This is not the case for PC containing blends according to EP 0373465 A2 for example since the addition of polycarbonate impairs the dimensional stability of PC blend-containing articles of manufacture at high temperatures. The inventive combination of components B) and C) makes available for the first time articles of manufacture based on polyalkylene terephthalates (component A)) that can be ESTA painted in an online process while simultaneously exhibiting no moisture-dependent changes in dimension in the manner of established materials based on polyamide and/or polyphenylene ether.

It is noted for the avoidance of doubt that the scope of the present invention encompasses ail below-referenced definitions and parameters referred to in general terms or within preferred ranges in any desired combinations.

Specific surface resistance is a measure of the capacity to resist the surface current flowing along the surface of a plastic molding. This parameter depends on environmental conditions and on the test specimen. When determining specific surface resistance, atmospheric humidity, impurities on the surface of the test specimen, test specimen size and electrode shape and configuration play a decisive role. The parameter of plastics referred to as electrostatic properties depends on the specific surface resistance of the material and is classified according to DIN EN ISO 61340-5-1.

In the context of the present invention the surface resistance in Ω [ohms] was determined according to DIN IEC 60093 using round blanks of the material to be tested having a diameter of 80 mm and a thickness of 4 mm. To this end, silver electrodes were vapor-deposited on the round blank. In the context of the present invention the surface resistance is used for characterizing the possible use of paints on articles of manufacture according to the invention.

Customary deposition tests of, for example, electrodeposition paints on articles of manufacture to be painted by ESTA are monitored in the laboratory with the current-time curve. Integral parameters are ascertained therefrom. The increase in surface resistance associated with the buildup of a paint layer and the reduction in the current flow have the result that relatively uniform layer thicknesses of the paints may be achieved even on objects having complex shapes. The ratio of the layer thickness of inner regions and outer regions of articles having complex shapes is referred to as throwing power. Throwing power behavior is tested in special test facilities and in the context of the present invention according to BMW throwing power as per VOA 621-180. See in this regard: A. Goldschmidt and H.-J. Streitberger, BASF-Handbuch Lackiertechnik, BASF Coatings A G, Vincentz, Hannover, 2002, pages 504-507.

“Alkyl” in the context of the present invention refers to a straight-chain or branched, saturated hydrocarbon group. If for example an alkyl group or polyalkylene group having 1 to 4 carbon atoms is employed this may be described as a “lower alkyl group” and may preferably comprehend methyl (Me), ethyl (Et), propyl, in particular n-propyl and isopropyl, butyl, in particular n-butyl, isobutyl, sec-butyl, tert-butyl.

The person skilled in the art understands compounding to mean the plastics-industry term, synonymous with plastics processing, for improving plastics by admixing additive substances (fillers, additives etc.) for specific optimization of profiles of properties. Compounding is preferably effected in extruders, particularly preferably in corotating twin-screw extruders, counterrotating twin-screw extruders, planetary screw extruders or cocompounders and comprises the process operations conveying, melting, dispersing, mixing, degassing and pressure build-up. See also: https://de.wikipedia.orgiwiki/Compoundierung.

The standards recited in the context of this application relate to the edition current on the application date of the present invention.

### DETAILED DESCRIPTION OF THE INVENTION

### Component A)

In one embodiment, component A) may be polyalkylene terephthalate, also referred to as polyester, and may be produced by various processes, synthesized from a variety of building blocks, and, in a specific application, provided, alone or in combination with processing aids, stabilizers, polymeric alloying co-components, preferably elastomers, or else reinforcing materials, preferably mineral fillers or in particular glass fibres, and optionally further additives, to afford materials of construction having tailored combinations of properties. Also suitable in accordance with the invention and thus encompassed by the term “polyalkylene terephthalate” are blends comprising proportions of other polymers, wherein one or more compatibilizers may optionally be employed.

Preference is given to employing polybutylene terephthalate (PBT) [CAS No. 24968-12-5] which in turn is produced by known methods from terephthalic acid (or the reactive derivatives thereof) and butanediol (Kunststoff-Handbuch, Vol VIII, p 695 ff, Karl Hanser Verlag, Munich 1973). PBT is marketed under the brand Pocan® inter glia by Lanxess Deutschland GmbH, Cologne.

In one embodiment preference is given to using polyethylene terephthalate (PET) [CAS No. 25038-59-9] which is produced from ethylene glycol and terephthalic acid. In one embodiment preference is given to using polycyclohexylenedimethylene terephthalate (PCT) [CAS No. 25037-99-4] which is produced from 1,4-cyclohexanedimethanol and dimethyl terephthalate, available from Celanese Corp., Dallas, Tex., USA under the name ThermX®.

In one embodiment polyalkylene turanoates, preferably polyethylene furanoate (PEF) or polypropylene furanoat (PPF), are employed as component A). Polyalkylene furanoates are recovered from recycling processes when 2,5-furandicarboxylic acid [CAS No, 3238-40-2] is polymerized with glycols, preferably ethylene glycol or propylene glycol. The 2,5-furandicarboxylic acid is produced using the reactant hydroxymethylfurfural(HMF); Avantium, Amsterdam, The Netherlands. See also: BioPla Journal, No. 59, 2015, pages 12-17.

The polyalkylene terephthalates for use as component A) preferably comprise at least 80 mol %, preferably at least 90 mol %, based on the dicarboxylic acid, of terephthalic acid radicals.

In one embodiment the polyalkylene terephthalate for use as component A) in accordance with the invention may comprise in addition to terephthalic acid radicals up to 20 mol % of radicals of other aromatic dicarboxylic acids having 8 to 14 carbon atoms or radicals of aliphatic dicarboxylic acids having 4 to 12 carbon atoms, in particular radicals of phthalic acid, isophthalic acid, naphthalene-2,6-dicarboxylic acid, 4,4′-diphenyldicerboxylic acid, succinic acid, adipic acid, sebacic acid, azelaic acid, cyclohexanediacetic acid, cyclohexanedicarboxylic acid, 2,5-furandicarboxylio acid.

In one embodiment the polyalkylene terephthalate preferred for use as component A) in accordance with the invention may comprise in addition to the actual dial component up to 20 mol % of other aliphatic diols having 3 to 12 carbon atoms or up to 20 mol % of cycloaliphatic dials having 6 to 21 carbon atoms, preferably radicals of propane-1,3-diol, 2-ethylpropane-1,3-diol, neopentyl glycol, pentane-1,5-diol, hexane-1,6-diol, 1,4-cyclohexanedimethanol, 3-methylpentane-2,4-diol, 2-methylpentane-2,4-diol, 2,2,4-trimethylpentane-1,3-diol, 2,2,4 trimethylpentane-1,5-diol, 2-ethylhexane-1,3-diol, 2,2-diethylproparte-1,3-diol, hexane-2,5-diol, 1,4-di(β-hydroxyethoxy)benzene, 2,2-bis(4-hydroxycyclohexyl)proparre, 2,4-dihydroxy-1,1,3,3-tetramethylcyclobutane, 2,2-bis(3-β-hydroxyethoxyphenyl)propane and 2,2-bis(4-hydroxypropoxyphenyl)propane.

Polyalkylene terephthalates preferred for use as component A) have an intrinsic viscosity according to EN-ISO 1628/5 in the range from 30 to 150 cm³/g, particularly preferably in the range from 40 to 130 cm³/g, very particularly preferably in the range from 50 to 100 cm³/g, in each case measured in phenol/o-dichlorobenzene (1:1 part by weight) at 25° C. in an Ubbelohde viscometer. The intrinsic viscosity IV, also referred to as Staudinger Index or limiting viscosity, is proportional, according to the Mark-Houwink equation, to the average molecular mass, and is the extrapolation of the viscosity number VN for the case of vanishing polymer concentrations. It can be estimated from series of measurements or through the use of suitable approximation methods (e.g. Billmeyer), The VN [ml/g] is obtained from the measurement of the solution viscosity in a capillary viscometer, for example an Ubbelohde viscometer. The solution viscosity is a measure of the average molecular weight of a polymer. The determination is effected on dissolved polymer, with various solvents (formic acid, m-cresol, tetrachloroethane, phenol, 1,2-dichlorobenzene, etc.) and concentrations being used. Through the viscosity number VN it is possible to monitor the processing and service properties of polymers. Subjection of the polymer to thermal stress, ageing processes or the action of chemicals, weathering and light may be investigated by means of comparative measurements. In this connection see also: http://de.wikipedia.org/wiki/Viskosimetrie and “http://de.wikipedia.org/wiki/Mark-Houwink-Gleichung”.

The PBT preferred for use as component A) in accordance with the invention may also be employed in admixture with other polymers. The production of PBT blends for use in accordance with the invention is effected by compounding. During such a compounding operation customary additives, in particular mold release agents or elastomers, may additionally be added to the melt to improve the properties of the blends.

PBT preferred for use in accordance with the invention is available from Lanxess Deutschland GmbH, Cologne under the name Pocan® B 1300. PET for use in accordance with the invention is available from E.I. du Pont de Nemours and Company/DuPont de Nemours (Deutschland) GmbH, Neu Isenburg, under the name Rynite® PET.

### Component B)

Compositions according to the invention comprise at least one filler or reinforcer as component B). It is preferable to employ fillers or reinforcers in amounts in the range from 1 to 55 parts by mass based on 100 parts by mass of component A).

It is preferable to employ at least one filler or reinforcer from the series of mica, silicate, quartz, in particular quartz flour, talc [CAS No. 14807-96-6], titanium dioxide, amorphous silicas, barium sulfate, glass beads, glass flour and/or fibrous fillers and reinforcers based on glass fibers or carbon fibers.

Particular preference is given to using glass beads or glass flour, very particularly preferably glass beads. If glass beads are used indications regarding particle size distribution/particle sizes refer to so-called surface-based particle sizes in each case before incorporation into the thermoplastic molding material. Here, the diameters of the surfaces of the respective glass particles are related to the surfaces of imaginary spherical particles (spheres). This is preferably accomplished with an Ankersmid particle size analyser which operates by the principle of laser dimming (Eye Tech® with accompanying EyeTech® software and ACM-104 measuring cell, Ankersmid Lab, Oosterhout, The Netherlands).

All fillers and/or reinforcers for use as component B) may, due to processing to afford the molding material/an article of manufacture, have a lower d97/c150 value in said molding material/article of manufacture than the originally employed fillers/reinforcers.

In connection with the d50 and d97 values in this application and the determination and significance thereof, reference may be made to Chemie Ingenieur Technik (72) p. 273-276, 3/2000, Wiley-VCH Verlags GmbH, Weinheim, 2000, according to which the

d50 is that particle size below which 50% of the particles lie (median value), and the

d97 is that particle size below which 97% of the particles lie.

The fillers and reinforcers may be employed individually or as a mixture of two or more different fillers and/or reinforcers.

In a preferred embodiment the filler and/or reinforcer for use as component B) may be surfaces modified, particularly preferably with an adhesion promoter/adhesion promoter system, especially preferably an epoxide- or silane-based adhesion promoter/adhesion promoter system. However, pretreatment is not absolutely necessary.

In a particularly preferred embodiment, spherical glass beads, known as spheriglass, are employed as component B).

The fillers and/or reinforcers for use as component B), in particular glass beads or glass fibres, are preferably provided with a suitable size system, particularly preferably a share-based size system.

Very particularly preferred share-based adhesion promoters for pretreatment are silane compounds of general formula (I)

(X—(CH₂)_{q})ₖ—Si—(O—CᵣH₂ᵣ₊₁)₄₋ₖ (I)

In which the substituents are defined as follows:

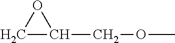

X: NH₂—, HO—,
q: an integer from 2 to 10, preferably from 3 to 4,
r: an integer from 1 to 5, preferably from 1 to 2,
k: an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane and the corresponding shares comprising a glycidyl group as the substituent X.

To modify the fillers and/or reinforcers, in particular glass beads or glass fibers, the share compounds are preferably employed in amounts in the range from 0.05 to 2 wt %, particularly preferably in the range from 0.25 to 1.5 wt % and in particular in the range from 0.5 to 1 wt %, relative to the filler/reinforcer, for surface coating.

Glass spheres for use with preference in accordance with the invention are available from Potters Industries LLC, Valley Forge, Pa. 19482, USA under the name Spheriglass® 3000 CP02.

### Component C)

Secondary alkanesulfonates (SAS) having two alkyl radicals are employed as component C). Preference is given to employing sodium salts of secondary alkanesulfonates (SAS) having two alkyl radicals as component C). Sulfonic acids where the radical group R is aliphatic are referred to as alkanesulfonic acids and the salts and esters thereof as alkylsulfonates or else as alkanesulfonates. Secondary alkanesulfonates for use as component C) in accordance with the invention feature a secondary carbon atom which in addition to the sulfonate bears two alkyl radicals and thus does not bear an aromatic radical as is the case in the above described prior art.

SAS [CAS No. 97489-15-1] are an economically important group of anionic surfactants, particularly in Europe, and are characterized by an isomer and homologue mixture of general formula (II)

R¹—HC(SO₃Na)—R² (II)

In which and Fe each independently of one another represent a C₁₀ to C₂₁ alkyl radical. Particular preference is given to sodium salts of the alkartesulfonic acid of formula (II) in which R¹ and A² each independently of one another represent C₁₆-C₁₈ alkyl radicals.

SAS is obtainable by suifoxidation or sultochlorination of straight-chain paraffins with subsequent neutralization/saponification of the sulfochlorides with aqueous sodium hydroxide solution. SAS are very readily biodegradable and have hitherto been used predominantly in dishwashing detergents, household cleaning products, but also in cosmetics, in emulsion polymerization or in fire extinguishants, SAS marketed by Lanxess Deutschland GmbH, Cologne under the brand Mersolat® are also customarily referred to as (C₁₀-C₂₁) alkylsulfonic esters, See also https://de.wikipedia.orgiwiki/Sulfons%C3%A4uren Especially preferably employed in accordance with the invention as component C) is Mersolat® H95, SDB Nr. 011693, sodium alkanesulfonates [CAS Nr. 68188-18-1], available from Lanxess Deutschland GmbH, Cologne.

It is preferable to employ SAS in amounts in the range from 0.5 to 20 parts by mass based on 100 parts by mass of component A). SAS preferred for use in accordance with the invention is available, for example, from Lanxess Deutschland GmbH, Cologne under the name Mersolat® H95.

### Component D)

In a preferred embodiment component D), at least one copolymer of at least one α-olefin with at least one methacrylic ester or acrylic ester of an aliphatic C₁-C₂₀ alcohol, is further employed in addition to components A), B) and C). Particularly preferred here are copolymers where the α-olefin is constructed from ethane and/or propene and the methacrylic ester or acrylic ester comprises as its alcohol component linear or branched alkyl groups having 6 to 20 C atoms. Very particular preference is given to using ethane as the α-olefin. Very particular preference is given to employing a copolymer of ethane and of an acrylic ester as component D). A copolymer only of ethane and only of one acrylic ester is especially preferred. A copolymer only of ethane and only of 2-ethylhexyl acrylate is especially particularly preferred. Copolymers for use as component D) in accordance with the invention are notable not only for the composition but also for the low molecular weight. Accordingly, preference is given in particular to copolymers having an MFI as measured at 190° C. under a load of 216 kg of at least 100 g/10 min, preferably of at least 150 g/10 min, more preferably of at least 300 g/10 min. The MFO melt flow index, serves to characterize the flow of a melt of a thermoplastic and is subject to the standards ISO 1133 or ASTM D 1236. The MFI, and all figures relating to the MFI in the context of the present invention, relate or were measured or determined in a standard manner according to ISO 1133 at 190° C. with a test weight of 2.16 kg.

It is preferable to employ component D) in amounts in the range from 1 to 15 parts by mass based on 100 parts by mass of component A).

### Component E)

In a preferred embodiment component E) at least one elastomer modifier is further employed in addition to components A), B), C) and D) or instead of D). It is preferable to employ component E) in amounts in the range from 1 to 35 parts by mass based on 100 parts by mass of component A). Elastomer modifiers preferred for use as component E) include inter glia one or more graft polymers of

E.1 5 to 95 wt %, preferably 30 to 90 wt %, of at least one vinyl monomer,

E.2 95 to 5 wt %, preferably 70 to 10 wt %, of one or more graft substrates having glass transition temperatures of <10° C., preferably <0° C., particularly preferably <−20° C., wherein the wt % values are based on 100 wt % of graft polymer E).

The graft substrate E2 generally has a median panicle size (d50) in the range from 0.05 to 10 μm, preferably in the range from 0.1 to 5 μm, particularly preferably in the range from 0.2 to 1 μm.

Monomers E.1 are preferably mixtures of

E1.1 50 to 99 wt % of vinylaromatics and/or ring-substituted vinylaromatics, in particular styrene, α-methylstyrene, p-methylstyrene, p-chlorostyrene, and/or (C₁-C₈)-alkyl methacrylates, in particular methyl methacrylate, ethyl methacrylate, and

E1.2 1 to 50 wt % of vinyl cyanides, in particular unsaturated nitriles such as acrylonitrile and methaorylonitrile and/or (C₁-C₈)-alkyl (meth)acrylates, in particular methyl methacrylate, glycidyl methacrylate, n-butyl acrylate, t-butyl acrylate, and/or derivatives, in particular anhydrides and imides of unsaturated carboxylic adds, in particular maleic anhydride or N-phenylmaleimide, wherein the wt % values are based on 100 wt % of monomer E.1.

Preferred monomers E1.1 are selected from at least one of the monomers styrene, α-methylstyrene and methyl methacrylate; preferred monomers F.1,2 are selected from at least one of the monomers acrylonitrile, maleic anhydride, glycidyl methacrylate and methyl methacrylate.

Particularly preferred monomers are E.1.1 styrene and E1.2 acrylonitrile,

Graft substrates E.2 suitable for the graft polymers to be employed in the elastomer modifiers are, for example, diene rubbers, EPDM rubbers, i.e. those based on ethylene/propylene and optionally diene, also acrylate, polyurethane, silicone, chloroprene and ethylene/vinyl acetate rubbers. EPDM stands for ethylene-propylene-diene rubber.

Preferred graft substrates E.2 are diene rubbers, in particular based on butadiene, isoprene etc,, or mixtures of diem rubbers or copolymers of diene rubbers or mixtures thereof with further copolymerizable monomers, especially as per E1.1 and E.1.2, with the proviso that the glass transition temperature of component E.2 is <10° C., preferably <0° C.; particularly preferably _{<}10° C.

Particularly preferred graft substrates E.2 are ABS polymers (emulsion, bulk and suspension ABS), wherein ABS stands for acrylonitrile-butadiene-styrene, as described, for example, in DE-A 2 035 390 (U.S. Pat. No. 3,644,574) or in DE-A 2 248 242 (=GB-A 1 409 275) or in Ullmann, Enzyklopädie der Technischen Chemie, vol 19 (1980), p. 280 ff. The gel content of the graft substrate E.2 is preferably at least 30 wt %, particularly preferably at least 40 wt % (measured in toluene) based on 100 wt % of graft substrate E.2. Very particular preference is given to a rubber based on an acrylonitrile-butadiene-styrene copolymer.

The elastomer modifiers/graft polymers are produced by free-radical polymerization, preferably by emulsion, suspension, solution or bulk polymerization, in particular by emulsion or bulk polymerization.

Particularly suitable graft rubbers also include ABS polymers, which are produced by redox initiation with an initiator system composed of organic hydroperoxide and ascorbic add according to U.S. Pat. No. 4,937,285.

Since, as is well known, the graft monomers are not necessarily fully grafted onto the graft substrate in the grafting reaction, according to the invention “graft polymers” is to be understood as also meaning products produced by (co)polymerization of the graft monomers in the presence of the graft substrate and cocbtained in the workup.

Likewise suitable acrylate rubbers are based on graft substrates E.2 which are preferably polymers of alkyl acrylates, optionally with up to 40 wt %, based on E.2, of other polymerizable, ethylenicaliy unsaturated monomers. The preferred polymerizable acryilc esters include C₁-C₈-alkyl esters, preferably methyl, ethyl, butyl, n-octyl and 2-ethylhexyl esters; naloalkyl esters, preferably halo-C₁-C₈-alkyl esters, preferably chloroethyl acrylate, glycidyl esters, and mixtures of these monomers. Graft polymers comprising butyl acrylate as the core and methyl methacrylates as the shell are particularly preferred.

Further preferentially suitable graft substrates according to E.2 are silicone rubbers comprising graft-active sites, such as are described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Crosslinking may be achieved by copolymerizing monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate: polyfunctional vinyl compounds, preferably di- and trivinylbenzenes, but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02 to 5 wt %, in particular 0.05 to 2 wt %, based on 100 wt % of the graft substrate E.

For cyclic crosslinking monomers having at least 3 ethylenically unsaturated groups it is advantageous to restrict the amount to below 1 wt % of the graft base E.2.

Preferred “other” polymerizable, ethylenically unsaturated monomers which, in addition to the acrylic esters, may optionally be used to prepare the graft substrate E.2 are acrylonitrile, styrene, α-rnethylsityrene, acrylamide, vinyl C₁-C₆-alkyl ethers, methyl methacrylate, glycidyl methacrylate, butadiene. Preferred acrylate rubbers as graft base E.2 are emulsion polymers having a gel content of at least 80 wt % based on 100 wt % of E.2.

As well as elastomer modifiers based on graft polymers, it is likewise possible to use elastomer modifiers which are not based on graft polymers and have glass transition temperatures of <10° C., preferably <0° C., particularly preferably <20° C. These preferably include elastomers having a block copolymer structure and additionally thermoplastically meltable elastomers, in particular EPM, EPDM and/or SEBS rubbers (EPM=ethylene-propylene copolymer, EPDM=ethylene-propylene-diene rubber and SEBS=styrene-ethene-butene-styrene copolymer).

### Component F)

In a preferred embodiment component F), at least one further additive, is further employed in addition to components A), B), C), D) and E) or instead of D) or instead of E) with the proviso that F) is distinct from A), B), C), D) or E). Iₜ is preferable to employ component F) in amounts in the range from 0.1 to 20 parts by mass based on 100 parts by mass of component A).

Preferred further additives in the context of the present invention are UV stabilizers, heat stabilizers, lubricants and mold release agents, fillers and reinforcers distinct from component B), nucleating agents, laser absorbers, di- or polyfunctional branching or chain-extending additives, hydrolysis stabilizers, antistats, emulsifiers, plasticizers, processing aids, flow assistants, elastomer modifiers and colourants distinct from component E). The respective additives may be used alone or in admixture/in the form of masterbatches.

Lubricants and mold release agents are preferably selected from the series of long-chain fatty acids, salts of long-chain fatty acids, ester derivatives of long-chain fatty acids and montan waxes.

Preferred long-chain fatty acids are stearic acid or behenic acid, Preferred salts of the long-chain fatty acids are calcium or zinc stearate. Preferred ester derivatives of long-chain fatty acids are those based on pentaerythritol, more particularly C₁₆-C₁₈ fatty acid esters of pentaerythritol [CAS No. 68604-44-4] or [CAS No. 85116-93-4].

Montan waxes in the context of the present invention are mixtures of straight-chain saturated carboxylic acids having chain lengths of from 28 to 32 carbon atoms. Particularly preferably employed in accordance with the invention are lubricants and/or mold release agents from the group of esters of saturated or unsaturated aliphatic carboxylic acids having 8 to 40 carbon atoms with aliphatic saturated alcohols having 2 to 40 carbon atoms and metal salts of saturated or unsaturated aliphatic carboxylic acids comprising 8 to 40 carbon atoms, wherein pentaerythritol tetrastearate, calcium stearate [CAS No. 1592-23-0] and/or ethylene glycol dimontanate, in particular Licowax® E [CAS No. 74388-22-0] from Clariant, Muttenz, Basel, are/is very particularly preferred and pentaerythritol tetrastearate [CAS No. 115-83-3], available from Emery Oleochemicals GmbH, Dusseldorf, Germany under the name Loxiol® P861 for example is especially particularly preferred.

Colorants employed are preferably organic pigments, preferably phthalocyanines, quinacridones, perylenes and dyes, preferably nigrosine or anthraquinones, also inorganic pigments, in particular titanium dioxide and/or barium sulphate, ultramarine blue, iron oxide, zinc sulphide or carbon black.

Plasticizers preferred for use as component F) are dioctyl phthalate, dibenzyl phthalate, butyl benzyl phthalate, hydrocarbon oils or N-(n-butyl)benzenesulphonamide.

Nucleating agents employed are preferably sodium and potassium salts of acetate, salicylate, stearate, saccharinate and partially saponified montan waxes and ionomers, and particularly preferably talc, provided this is not already present as component B), wherein this list is nonexhaustive,

Heat stabilizers preferred for use as component F) are selected from the group of sterically hindered phenols and aliphatically or aromatically substituted phosphites and also variously substituted representatives of these groups.

Among the sterically hindered phenols preference is given to employing those having at least one 3-tert-butyl-4-hydroxy-5-methylphenyl building block and/or at least one 3,5-d(tert-butyl-4-hydroxyphenyl) building block, particular preference being given to 1,6-hexanediol bis[3-(3,5-di-tert-butyl-4-hydroxyphenyl)propionate] [CAS No. 35074-77-2] (Irganox® 259 from BASF SE, Ludwigshafen, Germany), pentaerythritol tetrakis[3-(3,5-di-tert-butyl-4-hydroxyphenyl)propionate] [CAS No. 6683-19-8] (Irganox® 1010 from BASF SE) and 3,9-bis[2-[3-(3-tert-butyl-4-hydroxy-5-methylphenyl)propionyloxy]-1,1-dimethylethyl]-2,4,8,10-tetraoxaspiro[5,5]undecane [CAS No. 90498-90-1] (ADK Stab® AO 80). ADK Stab® AO 80 is commercially available from Adeka-Palmerole SAS, Mulhouse, France.

Among the aliphatically or aromatically substituted phosphonites preference is given to employing tetrakis(2,4-di-tert-butylphenyI)-4,4-biphenyldiphosphonite [CAS No. 119345-01-6], available for example from Clariant International Ltd, Muttenz, Switzerland under the name Hostanox® P-EPO, bis(2,4-dicumylphenyl)pentaerythritoldiphosphite [CAS No. 154882-43-8] available for example from Dover Chemical Corp., Dover, USA under the trade name Doverpihos® S9228 and/or tetrakis(2,4-di-tart-butylphenyl)-1,1-biphenyl-4,4′-diylbisphosphonite [CAS No. 38613-77-3].

The present invention, however, also relates to a substance mixture comprising at least one copolymer of at least one α-olefin with at least one acrylic ester of an aliphatic C₁-C₂₀ alkohol and at least one compound of formula R¹—HC(SO₃Na)—R², in which R¹ and R² each independently of one another represent a C₁₀-C₂₁ alkyl radical.

The invention, however, also relates to the use of the substance mixture comprising at least one copolymer of at least one α-olefin with at least one acrylic ester of an aliphatic C₁-C₂₀ alkohol and at least one compound of formula R¹—HC(SO₃Na)—R², in which R¹ and R² each independently of one another represent a C₁₀-C₂₁ alkyl radical, for improving the paint properties of polyalkylene terephthalate- or polyalkylene furanoate-based articles of manufacture. The invention preferably relates to the substance mixture comprising a copolymer only of ethene and only of 2-ethylhexyl acrylate and at least one compound of formula R¹—HC(SO₃Na)—R², in which R¹ and R² each independently of one another represent a C₁₀-C₂₁ alkyl radical.

In a preferred embodiment the present invention relates to compositions and molding materials and articles of manufacture producible therefrom comprising A) polybutylene terephthalate, B) glass beads and C) at least one compound of formula R¹—HC(SO₃Na)—R², in which R¹ and R² each independently of one another represent a C₁₀-C₂₁ alkyl radical.

In a preferred embodiment the present invention relates to compositions and molding materials and articles of manufacture producible therefrom comprising A) polybutylene terephthalate, B) glass beads and C) at least one compound of formula R¹—HC(SO₃Na)—R², in which R¹ and R² each independently of one another represent a C₁₀-C₂₁ alkyl radical and rubber based on an acrylonitrile-butadiene-styrene copolymer.

In a preferred embodiment the present invention relates to compositions and molding materials and articles of manufacture producible therefrom comprising A) polyethylene terephthalate, B) glass beads and C) at least one compound of formula R¹—HC(SO₃Na)—R², in which R¹ and R² each independently of one another represent a C₁₀-C₂₁ alkyl radical.

In a preferred embodiment the present invention relates to compositions and molding materials and articles of manufacture producible therefrom comprising A) polyethylene terephthalate, B) glass beads and C) at least one compound of formula R¹—HC(SO₃Na)—R², in which R¹ and R² each independently of one another represent a C₁₀-C₂₁ alkyl radical and at least one rubber based on an acrylonitrile-butadiene-styrene copolymer.

In a preferred embodiment the present invention relates to compositions and molding materials and articles of manufacture producible therefrom comprising A) polybutylene terephthalate, B) glass beads and C) at least one compound of formula R¹—HC(SO₃Na)—R², in which R¹ and R² each Independently of one another represent a C₁₀-C₂₁ alkyl radical and also F) talc and/or at least one copolymer of ethene and 2-ethylhexyl acrylate.

### Use

The present invention, however, also relates to the use of the compositions according to the invention, in particular in the form of molding compounds for production of articles of manufacture, preferably palatable articles of manufacture, particularly preferably of articles of manufacture that are subjected to an electrostatic spraying process (ESTA).

### Painting

Painting may be regarded as the most important process for applying a covering to industrial goods. A very wide variety of painting processes has therefore been developed for industrial application. Largely automated plants also allow rapid, uniform coating of parts in high volumes by spraying, curtain coating, roll coating or immersion. The invention comprehends painting processes from the group of low-pressure spraying, compressed air spraying, ultrahigh pressure spraying, hot spraying, electrostatic spraying, dip painting, curtain coating and roll coating.

### Compositions of Paints

Coatings and paints are mixtures of binders, pigments, solvents and diluents, fillers and additive substances. Binders serve to bind the pigment particles to one another and to the substrate to be painted. Pigments are inorganic or organic, chromatic or achromatic colorants which are virtually insoluble in the application medium. Solvents and diluents (e.g. spirit or turpentine) are a liquid consisting of one or more components which is able to dissolve the binder without chemical reaction. This gives the paint the viscosity required for processing. Fillers are pulverulent substances virtually insoluble in the application medium which serve to alter volume, to achieve or improve technical aspects and/or to influence optical properties. Additive substances are inter alia plasticizers, drying agents, hardeners, crosslinkers and flatting agents Plasticizers are important constituents for paints which are subsequently applied to parts that are to be subjected to forming. Hardeners are constituents of scratch-proof paints.

### Pretreatment of Workplace Surfaces

The surfaces of the articles of manufacture to be painted must generally be treated prior to an organic coating procedure in order to ensure good adhesion of the paint layer on the substrate, a problem-free coating process, uniform formation of the paint film and increased resistance to environmental influences. In pretreatment processes a distinction is made between mechanical and chemical processes.

### Painting Processes

Spraying atomizes liquids. This may be achieved using different physical effects, Painting technology employs two atomization principles, atomization by mechanical forces and atomization by electrical forces.

The efficiency of the different spraying processes differs significantly. The misdirected or deflected spray jet is known as overspray and can on account of the significant paint losses result in poor economy of the process and in pollution of the environment. Many different nozzle shapes are available for manual and automatic spray guns for painting such as the hollow cone eccentric nozzle, axial full cone nozzle, helix hollow cone nozzle, cluster nozzle, pneumatic atomizer with external mixing or the supersonic pneumatic atomizer with internal mixing. Paint application is generally achieved using atomizer nozzles which fully fill the area to be painted. A section through a pneumatic atomizer shows that the dividing of the paint into droplets, and the onward conveying, is effected therein via air streams exiting at various positions. Nozzles that operate with gas and liquid are known as two material nozzles.

The most commonly used painting processes are briefly introduced and characterized below.

### Low Pressure Spraying

This process is performed with special low pressure spraying apparatuses (“electric spray guns”) which operate with a spraying pressure of 0.2-0.5 bar. Here, the air is not compressed as in compressed air spraying but rather is passed to the gun directly from a rotary blower without an intermediate air chamber. The process is generally used where the coating is not expected to meet high standards of appearance. It is suitable for processing thin or highly dilute paints.

In compressed air spraying dispersion and application of the coating material is via compressed air (1 to 5 bar) which must be free from water and oil. Spray guns in which the compressed air flows at high speed are used therefor. The coating material is aspirated by means of a nozzle system and atomized in a spray cone which may be adapted to the particular requirements. Compressed air spraying makes it possible to spray quite high-viscosity, pigment-rich and low-solvent coating materials.

### Ultrahigh Pressure Spraying (Airless Spraying)

In this process the coating material is forced through the spraying nozzle hydraulically without admixing with air under a pressure of approximately 100 to 400 bar. This high pressure is generated by a compressed air or electrically operated piston pump. Atomization is achieved upon leaving the nozzle. The rapid expansion in combination with the air resistance and the mechanical resistance forms very small drops. The jet of coating material is free from air. The air supplied to the gun is used for servo control of the needle or for cleaning. The high flow rate makes the process suitable for large continuous surfaces.

Kot spraying allows problem-free processing of highly viscous, low-solvent paints on account of the reduction in viscosity of the paint with increasing temperature. This may be achieved with or without air assistance by compressed air atomization or airless atomization. The heating of the material to about 55° C. to 70° C. is effected directly in the beaker of the gun or via heat exchangers with a recirculating hot water or hot paint system. Hot spraying allows high individual layer thicknesses and is often employed in conjunction with high pressure spraying.

### Electrostatic Spraying (ESTA)

A DC voltage of 30 kV to 50 kV has been applied between the article of manufacture to be painted and the spray gun which results in the formation of a strong electric field. As soon as the coating material, preferably wet paint (electrostatic wet painting) or powder paint (electrostatic powder painting), leaves the gun muzzle it is electrically charged and follows the field lines as if magnetically attracted. Since the coating material particles have a homopolar charge they repel one another in flight to form a homogeneously sprayed jet. The particles land on the surface in a similar uniform fashion. Even particles that would normally fly past are deflected and accelerated toward the workpiece on account of the great attractive force.

If the atomization is effected by mechanical means, preferably by compressed air spraying, airless spraying or by rotary atomizers the term electrostatically assisted painting is used. Charging may be effected inside (internal charging) or outside (external charging) the spraying means (see also corona charging) Since the paint particles largely follow the electrical field lines between the charging electrode (atomizer) and the counterelectrode (earthed workpiece), electrostatically assisted painting of wet paints operates with an increased application efficiency compared to processes that are not electrostatically assisted. The paintability of EST, painted articles of manufacture is evaluated through the so-called throwing power as described above.

In dip painting the articles of manufacture to be painted are immersed in the paint and, once fully wetted, removed again. Since the articles of manufacture must be fully immersed in the paint they must not float, i.e. they must have a greater density than the paint. No air bubbles must remain upon immersion since these areas otherwise do not receive any paint. No paint must be scooped out with the painted article of manufacture upon withdrawal since larger amounts of paint undergo only insufficient hardening. The articles of manufacture to be painted must also be completely clean before painting! Dip painting is suitable for applying primer or top coats subject to low demands (e.g. for agricultural machinery).

### Curtain Coating

Curtain coating machines are large tables having a surface composed of rollers or conveyor belts which transport the object to be painted through the painting operation at a variable rate. To this end, the paint is pumped with a conveying pump from a reservoir into the so-called curtain coating head. This is a vessel which extends over the entire width of the conveying apparatus with an adjustable slot on the underside through which the paint runs vertically downward/onto the workpiece in a wide continuous paint curtain. The curtain coating process is applied especially for flat or curved, very large objects which cannot be painted with the roll coating process.

In roll coating the coating material is transferred onto the workpiece surface from rotating rubber roils. An adjustable slot between the application roll and the metering roll makes it possible to establish the desired paint application amounts. The workpiece surfaces may be coated on one or both sides. In co-roll coating the workpiece and the painting roll move in the same direction and in counter-roll coating they move in opposite directions. Roll coating is used to paint metal tapes, furniture parts, sheet metals, tin cans and buckets.

The present invention relates to the use of articles of manufacture comprising the compositions according to the invention in at least one of the recited painting processes, preferably in an electrostatic spraying process (ESTA).

The present invention further relates to the use of painted articles of manufacture comprising the compositions according to the invention in the motor vehicle industry, preferably as motor vehicle body parts, particularly preferably as wings, bumpers, spoilers, housings or filler caps/filler flaps.

### Production Process

The present invention further relates to a process for producing articles of manufacture where the individual components of the compositions according to the invention are mixed to afford a molding material, said material is extruded, cooled until pelletizable, pelletized and subjected to injection molding.

These are preferably articles of manufacture for the motor vehicle industry.

Preference is given to mixing at temperatures in the range from 240 to 310° C., preferably in the range from 260 to 300° C., more preferably in the range from 270 to 295° C., in the melt, Especially preferably, a twin-shaft extruder is used for this purpose.

In one embodiment, the pellet material comprising the composition according to the invention is dried, preferably at temperatures in the range of 120° C. in a vacuum drying cabinet or in a dry air drier for a period in the range of 2 h, before being subjected to injection moulding, to produce articles of manufacture according to the invention, and then a painting process.

The processes of injection moulding polyalkylene terephthalate-based molding materials are known to those skilled in the art.

Processes according to the invention for producing polyalkylene terephthalate-based articles of manufacture by injection moulding preferably operate at melt temperatures in the range from 240° C. to 330° C., particularly preferably in the range from 260 to 300° C., very particularly preferably in the range from 270 to 290° C., and optionally, in addition, at pressures of not more than 2500 bar, preferably et pressures of not more than 2000 bar, particularly preferably at pressures of not more than 1500 bar and very particularly preferably at pressures of not more than 750 bar.

In the process of injection moulding a moulding material comprising the compositions according to the invention, preferably in pellet form, is melted in a heated cylindrical cavity (i.e. plasticated) and injected under pressure into a heated cavity as the injection material. After cooling (solidification) of the material, the injection molding is demolded.

The following operations are distinguished:
1. plastication/melting
2. injection phase (filling operation)
3. hold pressure phase (because of thermal contraction during crystallization)
4. demolding.

In this regard, see http://de.wikipedia.orglwikliSpritzgie%C3%9Fen. An injection molding machine comprises a closure unit, the injection unit, the drive and the control system. The closure unit includes fixed and movable platens for the mould, an end platen, and tie bars and drive for the movable mould platen (toggle joint or hydraulic closure unit).

An injection unit comprises the electrically heatable barrel, the drive for the screw (motor, transmission) and the hydraulics for moving the screw and the injection unit. The injection unit serves to melt, meter, inject and exert hold pressure (because of contraction) on the powder/the pelletized material. The problem of melt backflow inside the screw (leakage flow) is solved by nonreturn valves.

In the injection mould, the incoming melt is then separated and cooled and the article of manufacture to be fabricated is thus fabricated. At least two mould halves are always required therefor. In injection moulding, the following functional systems are distinguished:
runner system
shaping inserts
venting
machine mounting and force absorption
demoulding system and motion transmission
temperature control

It will be understood that the specification and examples are illustrative but not (imitative of the present invention and that other embodiments within the spirit and scope of the invention will suggest themselves to those skilled in the art.

### Examples

To demonstrate the surprisingly found properties and the resulting possibilities for painting articles of manufacture based on the compositions according to the invention appropriate polyester molding materials were initially manufactured by compounding. To this end, the individual components were mixed in a twin-screw extruder (ZSK 32 Mega Compounder from Coperion Werner & Pfleiderer (Stuttgart, Germany)) at temperatures in the range from 260° C. to 300° C., extruded, cooled until pelletizable and pelletized. After drying (generally 2 h at 120° C. in a vacuum drying cabinet), the pellets were processed to form test specimens.

The test specimens for the investigations reported in Table 1 were injection-moulded on an injection moulding machine at a melt temperature of 260° C. and a mould temperature of 80° C.:
Round blanks of 80 mm diameter, 4 mm thickness
Eurosheet: 300 mm×15 mm×3 mm

Each test was performed on 5 test specimens and the average determined from the results.

### Paint Type for Paint Adhesion

Primer: R1218; Basecoat: R2342; Clearcoat: R3209E. The paints are commercially available from Karl Wörwag Lack-und Farbenlabrik GmbH & Co. KG, Stuttgart, Germany,

### Paint Adhesion

Cross-cut: The test was performed as per ISO 2490: A “+” indicates a score of GT0, i.e. no separation is apparent. A score of “−” corresponds to a score of GT5, i.e. the spelled area is >65%.

### Paint Type for ETA Painting

Basecoat: R2342; Clearcoat: R3203HE, The paints are commercially available from Karl Wörwag Lack-und Farbenfabrik GmbH & CO. KG, Stuttgart, Germany.

### Components Used in the Experiments

Component A): Linear polybutylene terephthalate (Pocan® B 1300, commercial product of Lanxess Deutschland GmbH, Leverkusen, Germany) having an intrinsic viscosity of 93 cm³/g (measured in phenol: 1,2-dichlorobertzene=1:1 at 25° C.)

Component B): Spheriglass® 3000 CP02, glass beads, commercially available from Potters Industries LLC, Valley Forge, Pa. 19482, USA

Component C): Mersolat® H95, SDB No 011693, sodium alkanesultonates [CAS No. 68188-181], obtainable from Lanxess Deutschland GmbH, Cologne

Component D): Lotryl® EH 550, [CAS No, 26984-27-0]copolymer of ethane and 2-ethylhexyl acrylate, obtainable from Arkema, Puteaux, France

Component F): Further additives customary for use in polyesters, for example mold release agents (e.g. pentaerythritol tatrastearate (PETS)), heat stabilizers for example based on phenyl phosphites such as pentaerythritol tetrakis[3-(3,5-d1-tert-butyl-4-hydroxyphenyl)propionate] [CAS-No. 6683-19-8] (Irganox® 1010 from BASF SE) and nucleating agents for example talc, Mistron® R10, obtainable from Imerys Talc Group, Toulouse, France. The nature and amount of the additives referred to collectively as component F) correspond in terms of nature and amount for the examples and comparative examples.

The proportions of the components in each case sum to 100 wt % in Table 1.

TABLE 1
(All values reported in wt %)

| | Example | Example | Comp. |
|---|---|---|---|
| | 1 | 2 | example 1 |
| A) | 72.8 | 68.8 | 75.8 |
| B) | 20.0 | 20.0 | 20.0 |
| C) | 3.0 | 7.0 | |
| D) | 4 | 4 | 4 |
| F | 0.2 | 0.2 | 0.2 |
| Spec. surface | 4.22E+13 | 2.73E+11 | 5.12E+16 |
| resistance [ohms] | | | |
| Throwing power | + | ++ | ∘ |
| in ESTA painting | | | |

The examples M Table 1 show that the use of component C) results in a reduction in surface resistance of 10 to 10⁵ ohms compared to the comparison without component C). The thus increasing surface conductivity therefore qualifies the material for electrostatic painting compared to a material without component C). This can be shown in practice by a good throwing power of the paint on the side of the substrate facing away from the paint gun. By contrast materials without component C) show no throwing power. Yet, addition of component C) does not negatively affect the mechanical properties as is familiar from other conductivity additives, for example carbon black and carbon nanotubes (CNT).

TABLE 2
(All values reported in wt %)

| | Example | Comp. |
|---|---|---|
| | 3 | example 2 |
| A) | 70.8 | 75.8 |
| B) | 20.0 | 20.0 |
| C) | 5.0 | |
| D) | 4 | 4 |
| F | 0.2 | 0.2 |
| Paint | + | − |
| adhesion | | |

Example 3 in Table 2 shows that articles of manufacture based on a molding material according to the invention comprising a combination of components C)+D) feature improved paint adhesion compared to articles of manufacture based on a molding material from comparative example 2 without component C).

A combination of PBT as component A) with components B) and C) further features high heat resistance so that such materials, as a constituent of a vehicle body, may pass through all steps of a painting process in customarily employed paint lines, including cathodic dip painting (CDP) without any need for special measures. This saves time and money. Finally, articles of manufacture based on compositions according to the invention feature very low water absorption thus ensuring dimensional stability independent of climate which is of great importance in particular in visible external vehicle body parts, for example filler flaps.

What is claimed is:

1. A thermoplastic molding composition comprising:
at least one polyalkylene terephthalate or polyalkylene furanoate;
at least one filler or reinforcer; and
at least one secondary alkanesulfonate having two alkyl radicals.

2. The composition according to claim 1, wherein the at least one secondary alkanesulfonate is an isomer and homologue mixture of general formula (II)
R¹—HC(SO₃Na)—R² (II)
in which R¹ and R², each independently of one another, represent a C₁₀ to C₂₁ alkyl radical.

3. The composition according to claim 2, wherein R¹ and A², each independently of one another, represent C₁₆-C₁₈ alkyl radicals.

4. The composition according to claim 1, wherein the at least one polyalkylene terephthalate or polyalkylene furanoate is polybutylene terephthalate or polyethylene terephthalate.

5. The composition according to claim 1, wherein the at least one polyalkylene terephthalate or polyalkylene furanoate is polybutylene terephthalate.

6. The composition according to claim 1, wherein the at least one polyalkylene terephthalate or polyalkylene furanoate is polyethylene furanoate, or polypropylene furanoate.

7. The composition according to claim 1, wherein:
the at least one polyalkylene terephthalate or polyalkylene furanoate is at least one of;
polybutylene terephthalate, polyethylene furanoate, and polypropylene furanoate; and
the at least one secondary alkanesulfonate is an isomer and homologue mixture of general formula (II)
R¹—HC(SO₃Na)—R² (II)
in which R¹ and R², each independently of one another, represent C₁₆-C₁₈ alkyl radicals.

8. The composition according to claim 7, wherein the at least one filler or reinforcer is selected from the group consisting of mica, silicate, quartz, quartz flour, talc, titanium dioxide, amorphous silicas, barium sulfate, glass beads, glass flour, and fibrous fillers, and reinforcers based on glass fibers, and reinforcers based on carbon fibers.

9. The composition according to claim 1, wherein the at least one filler or reinforcer is glass beads or glass flour.

10. The composition according to claim 1, wherein the at least one filler or reinforcer is glass beads.

11. The composition according to claim 1, wherein the at least one filler or reinforce comprises an adhesion promoter or an adhesion promoter system.

12. The composition according to claim 11, wherein the adhesion promoter or adhesion promoter system comprises a silane-based adhesion promoter or adhesion promoter system.

13. The composition according to claim 1, further comprising at least one copolymer of at least one α-olefin with at least one methacrylic ester or acrylic ester of an aliphatic C₁-C₂₀ alcohol.

14. The composition according to claim 13, wherein the at least one copolymer comprises a copolymer of ethene and 2-ethylhexyl acrylate.

15. A substance mixture comprising:
at least one copolymer of at least one α-olefin with at least one acrylic ester of an aliphatic C₁-C₂₀ alcohol; and
at least one compound of formula R¹—HC(SO₃Na)—R², in which R¹ and R² each independently of one another represent a C₁₀-C₂₁ alkyl radical.

16. The substance mixture according to claim 15, wherein the at least one copolymer is a copolymer of ethene and 2-ethylhexyl acrylate.

17. A process for producing articles of manufacture using the compositions according to claim 1, the process comprising:
mixing the components of the compositions according to claim 1 to produce a molding material;
extruding the molding material;
cooled the extruded molding material until pelletizable;
pelletized the extruded molding material to form pellets; and
subjected the pellets to injection molding to form the articles of manufacture.

18. The process according to claim 18, wherein the articles are paintable articles of manufacture, and the process further comprises electrostatically painting the articles of manufacture.

19. A process for producing articles of manufacture using the substance mixture according to claim 15, the process comprising:
mixing the components of the mixture according to claim 15 to produce a molding material;
extruding the molding material;
cooled the extruded molding material until pelletizable;
pelletized the extruded molding material to form pellets; and
subjected the pellets to injection molding to form the articles of manufacture.

20. The process according to claim 19, wherein the articles are paintable articles of manufacture, and the process further comprises electrostatically painting the articles of manufacture.
